(19) United States
(12) Patent Application Publication
(10) Pub. No.: US 2025/0132501 A1
(43) Pub. Date: Apr. 24, 2025

(54) TRANSMISSION APPARATUS AND TRANSMISSION SYSTEM

(71) Applicant: CANON KABUSHIKI KAISHA, Tokyo (JP)

(72) Inventor: TAKAYA NISHIZAWA, Kanagawa (JP)

(21) Appl. No.: 18/905,981

(22) Filed: Oct. 3, 2024

(30) Foreign Application Priority Data
Oct. 18, 2023 (JP) 2023-179582

(51) Int. Cl. H01Q 13/10

(52) U.S. Cl. CPC H01Q 13/106

(57) ABSTRACT

A transmission apparatus that transmits a signal by electromagnetic coupling to another communication apparatus and extends in a predetermined direction includes a conductor and a substrate including a first electrode, a second electrode, and a third electrode. On a plane perpendicular to the predetermined direction, the third electrode is positioned between the first electrode and the second electrode. The conductor and the third electrode function as a reference potential of the first electrode and the second electrode.

### BACKGROUND

### Field

The present disclosure relates to a transmission apparatus and a transmission system.

### Description of the Related Art

Recently proposed short-range wireless communication systems perform wireless communication between devices in a short range through electromagnetic coupling. Demands for high-speed communication and high-capacity communication, such as transmission of image data, have been increased. Japanese Patent Application Laid-Open No. 2001-230606 discusses a transmission apparatus that is used in such a short-range wireless communication system. The transmission apparatus includes space between a substrate on which a transmission line is arranged and a portion serving as a reference potential, thus reducing transmission loss.

In the wireless communication system using the electromagnetic coupling, the use of the transmission line with a low transmission loss as discussed in Japanese Patent Application Laid-Open No. 2001-230606 can enhance communication efficiency.

### SUMMARY

According to an aspect of the present disclosure, a transmission apparatus that transmits a signal by electromagnetic coupling to another communication apparatus and extends in a predetermined direction includes a conductor, and a substrate including a first electrode, a second electrode, and a third electrode, wherein, on a plane perpendicular to the predetermined direction, the third electrode is positioned between the first electrode and the second electrode, and wherein the conductor and the third electrode function as a reference potential of the first electrode and the second electrode.

Further features of the present disclosure will become apparent from the following description of exemplary embodiments with reference to the attached drawings.

### BRIEF DESCRIPTION OF THE DRAWINGS

FIGS. 1A and 1B are schematic diagrams each illustrating a configuration of a transmission apparatus according to a first exemplary embodiment.

FIGS. 2A and 2B are schematic diagrams each illustrating a configuration of a transmission apparatus according to a comparative example.

FIG. 3 is a graph in which a horizontal axis indicates a ratio of space between a third electrode and each of first and second electrodes to widths of the first and second electrodes, and a vertical axis indicates a rate of change in differential impedance when a height of a supporting member is changed.

FIGS. 4A and 4B are schematic diagrams each illustrating a configuration of a transmission apparatus according to a second exemplary embodiment.

FIG. 5 is a schematic diagram illustrating a case where a position at which a substrate is connected to a supporting member deviates due to a manufacturing error in the transmission apparatus according to the second exemplary embodiment.

FIGS. 6A, 6B, and 6C are schematic diagrams illustrating a case where widths of supporting members are changed due to a manufacturing error in the transmission apparatus according to the second exemplary embodiment.

FIGS. 7A and 7B are schematic diagrams each illustrating a first example of a configuration of a transmission system according to a third exemplary embodiment.

FIG. 8 is a schematic diagram illustrating a second example of a configuration of the transmission system according to the third exemplary embodiment.

### DESCRIPTION OF THE EMBODIMENTS

Hereinafter, exemplary embodiments are described in detail with reference to the drawings. In the following description, configurations that are common throughout a plurality of drawings are given the same reference code. The common configuration is described by referring to the plurality of the drawings, and description of the configuration having the same reference code may be appropriately omitted.

### [Configuration of Transmission Apparatus]

A first exemplary embodiment of the present disclosure will be described below. A transmission apparatus 10 according to a first exemplary embodiment will initially be described.

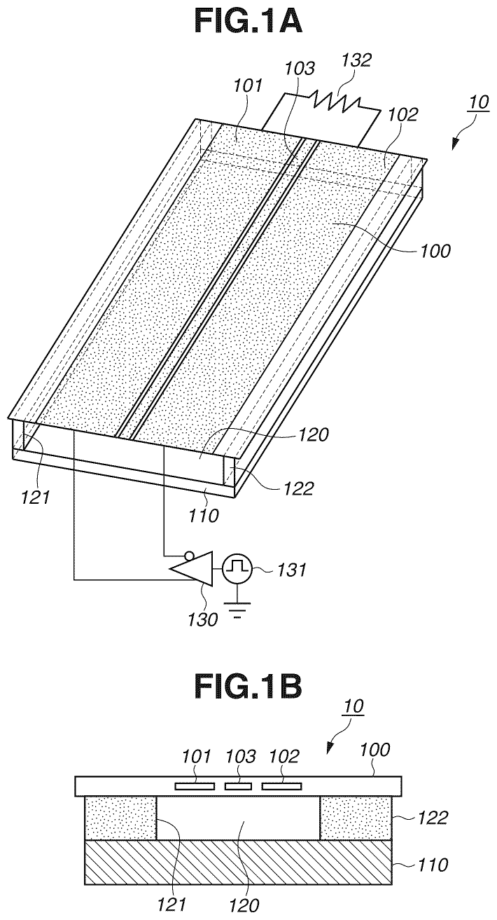

FIGS. 1A and 1B are schematic diagrams each illustrating the transmission apparatus 10 according to the present exemplary embodiment. FIG. 1A is a perspective view of the transmission apparatus 10, and FIG. 1B is a sectional view of a transmission line of the transmission apparatus 10 as seen from an extension direction.

The transmission apparatus 10 of the present embodiment includes a conductor 110 and a substrate 100 arranged above the conductor 110.

The conductor 110 is, for example, a metal plate including aluminum that is a metal material having good conductivity. The conductor 110 is a ground plane, and is set to a reference potential of a differential transmission line that is described below.

The substrate 100 is, for example, a flexible printed-circuit board. The substrate 100 includes a first electrode 101 and a second electrode 102 that extend in parallel to each other and are served as a microstrip line. The first electrode 101 has a thickness and a width that are substantially the same as those of the second electrode 102. The first electrode 101 and the second electrode 102 form a transmission line, here, a differential transmission line. The differential transmission line including the first electrode 101 and the second electrode 102 has one end that is connected to a differential transmission buffer 130, and the differential transmission buffer 130 is connected to a signal source 131. An electric signal output from the signal source 131 is input as a differential signal to the differential transmission line via the differential transmission buffer 130 connected to one end (an input unit) of the differential transmission line. The first electrode 101 and the second electrode 102 forming the differential transmission line have the other ends that are terminated by a termination resistor 132 that is substantially equal to characteristic impedance.

In the present exemplary embodiment, the substrate 100 includes a third electrode 103 between the first electrode 101 and the second electrode 102. The third electrode 103 is spaced a certain distance apart from each of the first and second electrodes 101 and 102, and extends in parallel to the first and second electrodes 101 and 102. The third electrode 103 is set to a reference potential of the differential transmission line. The third electrode 103 has a thickness that is substantially the same as that of each of the first and second electrodes 101 and 102. The third electrode 103 has a width that is smaller than that of each of the first and second electrodes 101 and 102. In the substrate 100, the first, second, and third electrodes 101, 102, and 103 are positioned on a virtual flat surface at a certain distance from an upper surface of the conductor 110 of the substrate 100, and heights of the first, second, and third electrodes 101, 102, and 103 from the upper surface of the conductor 110 are substantially equal. This configuration strongly maintains electromagnetic coupling of the first electrode 101 to the third electrode 103, and electromagnetic coupling of the second electrode 102 to the third electrode 103. The third electrode 103 and the conductor 110 are electrically connected at an end of the differential transmission line in an extension direction, and are at the same potential. The third electrode 103 and the conductor 110 function as a reference potential of the differential transmission line. This configuration reduces fluctuations in characteristic impedance even with the occurrence of a design error in manufacturing of the transmission apparatus 10.

On the conductor 110, supporting members 121 and 122 that support the substrate 100 are arranged. The supporting members 121 and 122 are each made of an insulator, for example, an insulating material having a relative dielectric constant that is substantially the same as that of the air. The supporting members 121 and 122 extend in parallel to the first and second electrodes 101 and 102 forming the differential transmission line. The arrangement of the supporting members 121 and 122 forms a void 120 between the conductor 110 and the substrate 100. The void 120 is, for example, filled with the air. Alternatively, it is conceivable that the void 120 may be filled with, for example, an insulating material having a dielectric constant that is close to that of the air in view of a strength of the transmission apparatus 10.

In the present exemplary embodiment, electromagnetic coupling of the first electrode 101 to the third electrode 103 and electromagnetic coupling of the second electrode 102 to the third electrode 103 are stronger than electromagnetic coupling of the first electrode 101 to the conductor 110 and the supporting member 121 and electromagnetic coupling of the second electrode 102 to the conductor 110 and the supporting member 122. A degree of electromagnetic coupling can be obtained by, for example, measuring a coupling coefficient.

### [Effect of Transmission Apparatus According to Present Exemplary Embodiment]

Hereinafter, actions and effects of the transmission apparatus 10 according to the present exemplary embodiment illustrated in FIGS. 1A and 1B are described based on comparison with a comparative example.

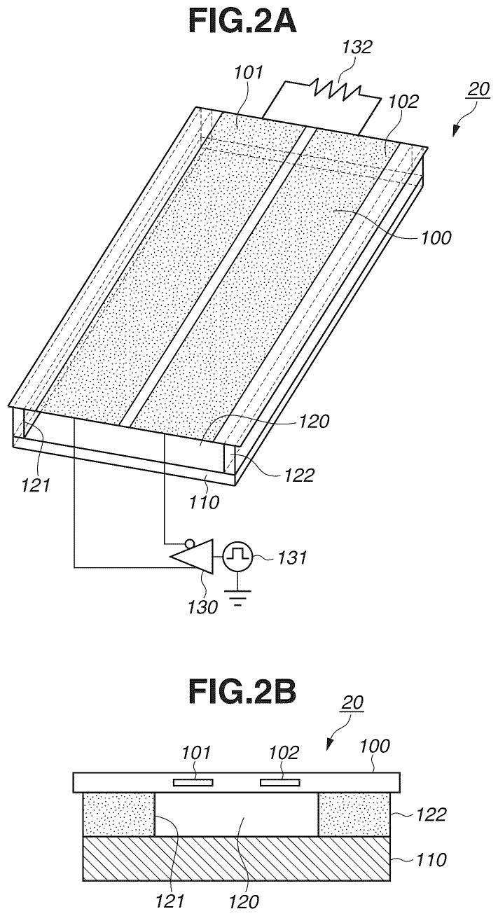

FIGS. 2A and 2B are schematic diagrams each illustrating a configuration of a transmission apparatus 20 according to a comparative example. FIG. 2A is a perspective view of the transmission apparatus 20, and FIG. 2B is a sectional view of a transmission line of the transmission apparatus 20 as seen from an extension direction.

The transmission apparatus 20 of the comparative example has a configuration without the third electrode 103 in the transmission apparatus 10 of the present exemplary embodiment. In the transmission apparatus 20, a reference potential of a differential transmission line is a conductor 110 only. Thus, in the transmission apparatus 20, a characteristic impedance is changed in a case where a positional relation between the conductor 110 and the substrate 100 is changed due to a manufacturing error in the conductor 110 or the supporting members 121 and 122 at the time of manufacture.

In contrast to this, in the transmission apparatus 10 according to the present exemplary embodiment, the third electrode 103 serving as a reference potential is present on the substrate 100 as illustrated in FIGS. 1A and 1B. The electromagnetic coupling of the third electrode 103 to each of the first electrode 101 and the second electrode 102 is stronger than that of the conductor 110 to each of the first and second electrodes 101 and 102. This arrangement of the third electrode 103 can reduce influence on the characteristic impedance even in a case wherewith a manufacturing error in the conductor 110 and/or the supporting members 121 and 122 at the time of manufacture.

Next, actions and effects of the transmission apparatus 10 will be described based on a result of analysis using a simulation.

In the simulation, the substrate 100 was a flexible printed-circuit board, and the void 120 was filled with the air. The conductor 110 and the third electrode 103 were connected at an end of the transmission line in an extension direction, and were at the same potential. Each of the supporting members 121 and 122 was set to have a relative dielectric constant substantially equal to that of the air.

The configuration of the transmission apparatus 10 of the present exemplary embodiment illustrated in FIGS. 1A and 1B was analyzed using the design parameters illustrated in Table 1. As a result, a characteristic impedance of the differential transmission line included a differential impedance of 88Ω and a single-ended impedance of 45Ω.

TABLE 1

| | NUMERIC VALUE |
|---|---|
| PARAMETER | [UNIT] |
| Width of electrode of differential | 7 [mm] |
| transmission line | |
| Width of electrode of reference | 3 [mm] |
| potential line on substrate | |
| Space between electrode of | 0.1 [mm] |
| differential transmission line and | |
| electrode of reference potential line | |
| Thickness of substrate | 0.115 [mm] |
| Relative dielectric constant of | 4.3 [mm] |
| substrate | |
| Width of conductor | 20 [mm] |
| Width of supporting member | 1 [mm] |
| Height of supporting member | 3 [mm] |
| Length of line | 300 [mm] |

Similarly, the configuration of the transmission apparatus 20 of the comparative example illustrated in FIGS. 2A and 2B was analyzed using the design parameters illustrated in Table 2 below. As a result, characteristic impedance of the differential transmission line included a differential impedance of 97Ω and a single-ended impedance of 65Ω.

TABLE 2

| PARAMETER | NUMERIC VALUE [UNIT] |
|---|---|
| Width of electrode of differential | 7 [mm] |
| transmission line | |
| Space between electrodes | 0.8 [mm] |
| Thickness of substrate | 0.115 [mm] |
| Relative dielectric constant of | 4.3 [mm] |
| substrate | |
| Width of conductor | 20 [mm] |
| Width of supporting member | 1 [mm] |
| Height of supporting member | 3 [mm] |
| Length of line | 300 [mm] |

A situation was analyzed through a simulation in which the transmission apparatus 10 according to the present exemplary embodiment illustrated in FIGS. 1A and 1B and the transmission apparatus 20 of the comparative example illustrated in FIGS. 2A and 2B are designed with the parameters in Tables 1 and 2 and with variations in a height of each of the supporting members 121 and 122 due to a manufacturing error. Here, influence on the characteristic impedance in a case where the first and second electrodes 101 and 102 and the conductor 110 deviates from designed values due to an increase in height of each of the supporting members 121 and 122 was simulated and analyzed.

A description is provided of the transmission apparatus 10 of the present exemplary embodiment illustrated in FIGS. 1A and 1B. With an increase in height of each of the supporting members 121 and 122 from 3 mm to 3.5 mm, a differential impedance became 90Ω, and a single-ended impedance became 46Ω. The differential impedance changed by approximately 2%, and the single-ended impedance changed by approximately 2%. With an increase in height of each of the supporting members 121 and 122 from 3 mm to 4 mm, a differential impedance became 93Ω, and a single-ended impedance became 47Ω. The differential impedance changed by approximately 5%, and the single-ended impedance changed by approximately 4%.

A description will be provided of the transmission apparatus 20 of the comparative example illustrated in FIGS. 2A and 2B. With an increase in height of each of the supporting members 121 and 122 from 3 mm to 3.5 mm, a differential impedance became 101Ω, and a single-ended impedance became 70Ω. The differential impedance changed by approximately 4%, and the single-ended impedance changed by approximately 7%. With an increase in height of each of the supporting members 121 and 122 from 3 mm to 4 mm, a differential impedance became 105Ω, and a single-ended impedance became 72Ω. The differential impedance changed by approximately 8%, and the single-ended impedance changed by approximately 10%.

In the above example, the heights of the supporting members 121 and 122 were changed in a case where no electrode serving as a reference potential was present between the lines of differential transmission lines as illustrated in the comparative example in FIGS. 2A and 2B. This case confirmed that a change in distance between the substrate 100 and the conductor 110 changed a distance between the reference potential and the differential transmission line, causing a significant change in the characteristic impedance.

In contrast, the heights of the supporting members 121 and 122 were changed with the third electrode 103 serving as a reference potential present between the lines of the differential transmission lines as in the present exemplary embodiment illustrated in FIGS. 1A and 1B. In this case, the characteristic impedance hardly changes due to the presence of the third electrode 103 serving as a reference potential even if a distance between the conductor 110 serving as a reference potential and the differential transmission line is changed by a change in distance between the substrate 100 and the conductor 110.

Thus, the use of the transmission apparatus 10 according to the present exemplary embodiment can reduce influence on a characteristic impedance and can maintain the quality of a transmission signal even with a manufacturing error in height of each of the supporting members 121 and 122.

In the above simulation experiment, heights of the supporting members 121 and 122 were set to be sufficiently greater than a distances between the third electrode 103 and each of the first electrode 101 and the second electrode 102. To acquire a significant effect including reduction in influence on the characteristic impedance resulting from a manufacturing error in heights of the supporting members 121 and 122, the electromagnetic coupling of the third electrode 103 as a reference potential of the differential transmission line to the first and second electrodes 101 and 102 is to be stronger than that of the conductor 110 to the first and second electrodes 101 and 102.

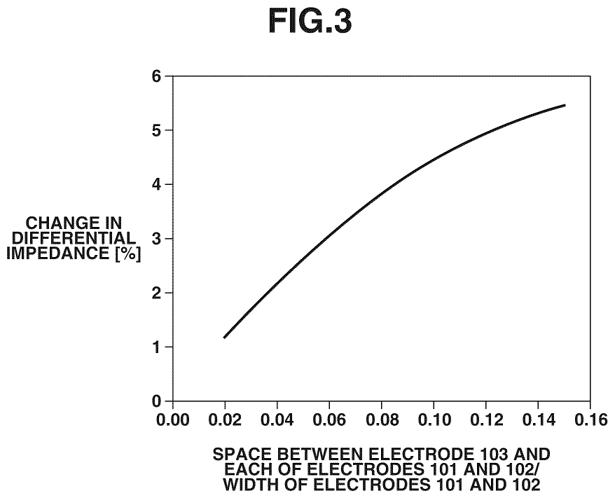

FIG. 3 is a graph in which a horizontal axis represents a ratio of space between the third electrode 103 and each of the first and second electrodes 101 and 102 to the widths of the first and second electrodes 101 and 102, and a vertical axis represents a rate of change in differential impedance when the height of each of the supporting members 121 and 122 is changed from 3 mm to 3.5 mm in the transmission apparatus 10.

As illustrated in FIG. 3, to keep the rate of the change in differential impedance to, for example, 5% or less relative to the change in the supporting members 121 and 122, the ratio of space between the third electrode 103 and each of the first and second electrodes 101 and 102 to the widths of the supporting members 121 and 122 is to be 0.12 or less. Accordingly, to reduce the influence on the characteristic impedance even with a change in heights of the supporting members 121 and 122 due to a manufacturing error, the first, second, and third electrodes 101, 102 and 103 are to be designed such that a distance between the third electrode 103 and each of the first and second electrodes 101 and 102 is shortened.

The present exemplary embodiment exemplifies a case in which the supporting members 121 and 122 are present between the conductor 110 and the substrate 100 across the length of the differential transmission line as illustrated in FIGS. 1A and 1B. However, the present exemplary embodiment is not limited thereto. For example, a supporting member may be arranged only in a predetermined portion of a differential transmission line in an extension direction, or a plurality of supporting members may be arranged in a differential transmission line in an extension direction.

According to the present exemplary embodiment, a transmission apparatus that reduces influence of manufacturing error in a transmission apparatus, maintains communication quality, and performs high-speed communication is realized, as described above.

### [Configuration of Transmission Apparatus]

Next, a transmission apparatus according to a second exemplary embodiment is described.

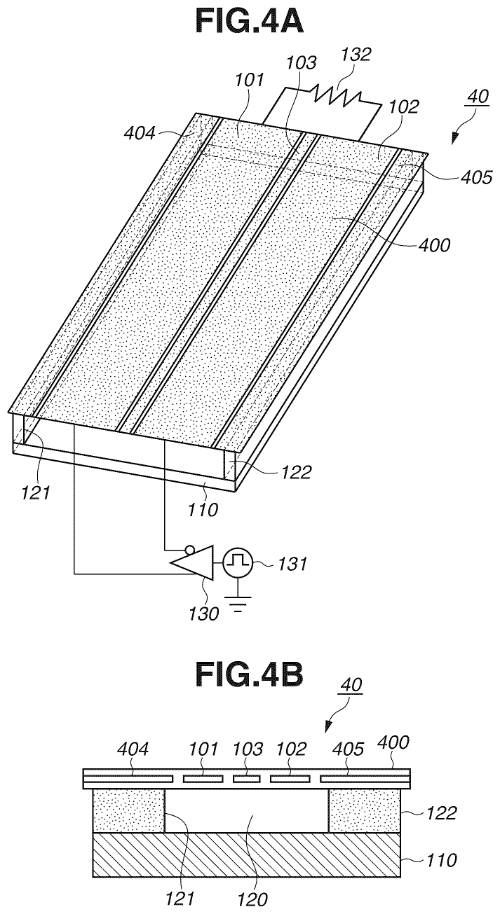

FIGS. 4A and 4B are diagrams illustrating a configuration of a transmission apparatus 40 according to the present exemplary embodiment. FIG. 4A is a perspective view of the transmission apparatus 40, and FIG. 4B is a sectional view illustrating a transmission line of the transmission apparatus 40 as seen from an extension direction.

The transmission apparatus 40 includes a conductor 110 that is similar to the conductor 110 of the transmission apparatus 10, and a substrate 400 arranged above the conductor 110.

As in the substrate 100 of the transmission apparatus 10, the substrate 400 includes a first electrode 101 and a second electrode 102 that form a differential transmission line, and a third electrode 103 that is formed between the first and second electrodes 101 and 102 and is set to a reference potential of the differential transmission line.

In the present exemplary embodiment, the substrate 400 includes a fourth electrode 404 and a fifth electrode 405 in addition to the first, second, and third electrodes 101, 102, and 103. The fourth and fifth electrodes 404 and 405 are spaced certain distances apart from these electrodes and extend in parallel to these electrodes. The fourth and fifth electrodes 404 and 405 are set to a reference potential of the differential transmission line. The fourth electrode 404 is disposed at a position adjacent to the first electrode 101 and on the opposite side of the first electrode 101 from the third electrode 103. The fifth electrode 405 is arranged at a position adjacent to the second electrode 102 and on the opposite side of the second electrode 102 from the third electrode 103. The fourth electrode 404 has a thickness and a width that are substantially the same as those of the fifth electrode 405. In the substrate 400, the first, second third, fourth, and fifth electrodes 101, 102, 103, 104, and 105 are positioned on a virtual flat surface at a certain distance from an upper surface of the conductor 110 of the substrate 400, and the heights of the first, second third, fourth, and fifth electrodes 101, 102, 103, 104, and 105 from the upper surface of the conductor 110 are substantially equal. This configuration strongly maintains electromagnetic coupling of the first electrode 101 to the third electrode 103, electromagnetic coupling of the second electrode 102 to the third electrode 103, electromagnetic coupling of the first electrode 101 to the fourth electrode 404, and electromagnetic coupling of the second electrode 102 to the fifth electrode 405. The third, fourth, and fifth electrodes 103, 404, and 405 and the conductor 110 are electrically connected at an end of the differential transmission line in the extension direction, and are at the same potential which is a reference potential of the differential transmission line in the present exemplary embodiment. This configuration reduces fluctuations in the characteristic impedance even with the occurrence of a design error in the differential transmission line and/or other elements.

As in the transmission apparatus 10, the transmission apparatus 40 includes supporting members 121 and 122 on the conductor 110, and has a void 120 between the conductor 110 and the substrate 400. The supporting members 121 and 122 support the substrate 400. The void 120 is filled with the air. Each of the supporting members 121 and 122 includes a conductor formed of, for example, aluminum that is a metal material having good conductivity. In the present exemplary embodiment, the conductor 110 and the supporting members 121 and 122 are configured as separate members. However, it is conceivable that the conductor 110 and the supporting members 121 and 122 can be integrally formed of the same conductive material.

In the present exemplary embodiment, the fourth electrode 404 is disposed to match a contact region in which the supporting member 121 contacts the substrate 400, whereas the fifth electrode 405 is disposed to match a contact region in which the supporting member 122 contacts the substrate 400. More specifically, the center position of the fourth electrode 404 substantially matches the center position of the supporting member 121 in the contact region, whereas the center position of the fifth electrode 405 substantially matches the center position of the supporting member 122 in the contact region. Thus, the fourth and fifth electrodes 404 and 405 are respectively disposed to match the contact regions in which the supporting members 121 and 122 contact the substrate 400, so that fluctuations in characteristic impedance can be reduced as small as possible even in a case where these positions slightly deviate due to a manufacturing error.

The fourth electrode 404 has a width that is greater than that of the supporting member 121 in the corresponding contact region. The fifth electrode 405 has a width that is greater than that of the supporting member 122 in the corresponding contact region. The adoption of this configuration reduces fluctuations in characteristic impedance as small as possible even in a case where the supporting members 121 and 122 become closer to the first and second electrodes 101 and 102, respectively, due to a manufacturing error.

As in the transmission apparatus 10, electromagnetic coupling of the first electrode 101 to the third electrode 103 and electromagnetic coupling of the second electrode 102 to the third electrode 103 are stronger than electromagnetic coupling of the first electrode 101 to the conductor 110 and the supporting member 121 and electromagnetic coupling of the second electrode 102 to the conductor 110 and the supporting member 122. In the present exemplary embodiment, electromagnetic coupling of the first electrode 101 to the fourth electrode 404, and electromagnetic coupling of the second electrode 102 to the fifth electrode 405 are made further stronger than electromagnetic coupling of the first electrode 101 to the conductor 110 and the supporting member 121 and electromagnetic coupling of the second electrode 102 to the conductor 110 and the supporting member 122.

### [Actions and Effects of Transmission Apparatus According to Present Exemplary Embodiment]

Hereinafter, actions and effects of the transmission apparatus 40 according to the present exemplary embodiment illustrated in FIGS. 4A and 4B will be described based on comparison with the comparative example.

The transmission apparatus 40 according to the present exemplary embodiment includes the third, fourth, and fifth electrodes 103, 404, and 405 as a reference potential on the substrate 400 as illustrated in FIGS. 4A and 4B. The electromagnetic coupling of the third, fourth, or fifth electrode 103, 404, and 405 to the first and second electrodes 101 and 102 is stronger than that to the conductor 110 and to the supporting members 121 and 122. Thus, influence on the characteristic impedance can be reduced even with the occurrence of a manufacturing error in the conductor 110 and/or the supporting members 121 and 122 at the time of manufacture.

Hereinafter, actions and effects of the transmission apparatus 40 will be described based on a result of analysis using a simulation. In the following simulation, each of the supporting members 121 and 122 is a member formed of the same metal as the conductor 110.

Initially, the characteristic impedance of a differential transmission line was analyzed through a simulation.

In addition to the parameters (Table 1) used in the simulation performed for the transmission apparatus 10 of the first exemplary embodiment described above, the widths of the fourth and fifth electrodes 404 and 405 were set to 2 mm. When the simulation was performed for the characteristic impedance of the differential transmission line, a differential impedance was 102Ω, and a single-ended impedance was 54Ω.

In a case where no electrode serving as a reference potential is present between the lines of the differential transmission line as in the comparative example illustrated in FIGS. 2A and 2B, with the supporting members 121 and 122 each serving as a member formed of the same metal as the conductor 110, an analysis was performed with the design parameters illustrated in Table 2. A result of the analysis indicated that a differential impedance was 97Ω, and a single-ended impedance was 64Ω.

Next, an analysis through a simulation was performed on influence on the characteristic impedance of the differential transmission line in a case where a position at which a substrate connects to a supporting member deviates due to a manufacturing error.

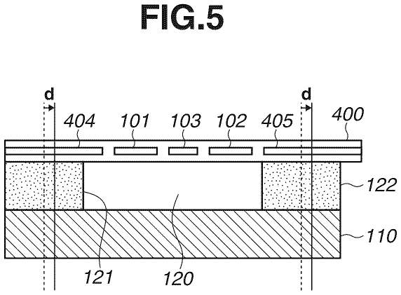

FIG. 5 is a schematic diagram illustrating a case in which positions at which the substrate 400 connects to the supporting members 121 and 122 deviate due to a manufacturing error in the transmission apparatus 40 of the present exemplary embodiment. Here, for parameters similar to those described above, a displacement amount d from the center position of the fourth electrode 404 (the fifth electrode 405) and the center position of the supporting member 121 (the supporting member 122) was set to 0.5 mm. Here, in the transmission apparatus 40 according to the present exemplary embodiment illustrated in FIG. 5, a differential impedance, a single-ended impedance of the first electrode 101, and a single-ended impedance of the second electrode 102 were respectively changed to 101Ω, 55Ω, and 53Ω.

In a case where no electrode serving as a reference potential was present between the lines of the differential transmission line according to the comparative example illustrated in FIGS. 2A and 2B, a situation was simulated in which positions at which the substrate 400 connects to the supporting members 121 and 122 deviate by 0.5 mm as in the configuration illustrated in FIG. 5. A result of the simulation indicated that a differential impedance, a single-ended impedance of the first electrode 101, and a single-ended impedance of the second electrode 102 were respectively changed to 96Ω, 66Ω, and 61Ω.

In a case where no electrode serving as a reference potential was present on the substrate 100 as in the comparative example, a single-ended impedance changed by approximately ±5% from a designed value, and a difference in impedance between the first electrode 101 and the second electrode 102 increased. In contrast to this, in a case where the electrodes 103, 404 and 405 serving as a reference potential are present on the substrate 400 as in the present exemplary embodiment, the analysis confirmed that a single-ended impedance changed by only approximately ±2% from a designed value, and a difference in impedance between the two electrodes barely occurred.

Thus, the analysis revealed that the use of the transmission apparatus 40 according to the present exemplary embodiment produces an advantageous effect of reducing the influence on the characteristic impedance of a differential transmission line due to an error in connection of the substrate 400 to the supporting members 121 and 122.

Next, an analysis through a simulation was performed on the influence on the characteristic impedance in a case where the widths of the supporting members 121 and 122 change due to a manufacturing error.

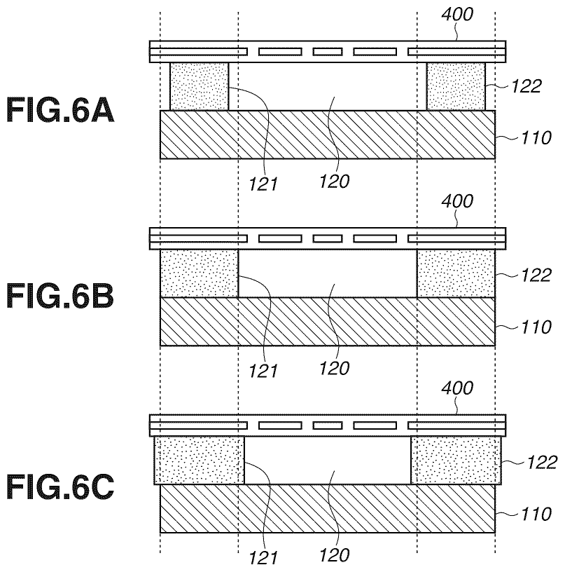

FIGS. 6A, 6B, and 6C are schematic diagrams illustrating a case where the widths of the supporting members 121 and 122 change due to a manufacturing error in the transmission apparatus 40 according to the present exemplary embodiment. FIG. 6B illustrates a case where there is no manufacturing error. FIG. 6A illustrates the supporting members 121 and 122 with the widths slightly narrower than those with no manufacturing error, whereas FIG. 6C illustrates the supporting members 121 and 122 with the widths slightly wider than those with no manufacturing error. Here, a simulation was performed using parameters similar to those described above with only the widths of the supporting members 121 and 122 changed by ±0.5 mm. In the transmission apparatus 40 according to the present embodiment illustrated in FIGS. 4A and 4B, when the widths of the supporting members 121 and 122 became 0.5 mm, the differential impedance and the single-ended impedance respectively changed to 101Ω and 54Ω. When the widths of the supporting members 121 and 122 became 1.5 mm, the differential impedance and the single-ended impedance respectively changed to 103Ω and 55Ω.

In a case where no electrode serving as a reference potential was present between the lines of the differential transmission line as in the comparative example illustrated in FIGS. 2A and 2B, a situation was simulated in which only the widths of the supporting members 121 and 122 changed by ±0.5 mm. A result of the simulation indicated that the differential impedance and the single-ended impedance respectively changed to 101Ω and 67Ω when the width of each of the supporting members 121 and 122 became 0.5 mm.

When the widths of the supporting members 121 and 122 became 1.5 mm, the differential impedance and the single-ended impedance respectively changed to 94Ω and 61Ω.

In a case where no electrode serving as a reference potential is present on the substrate 100 as in the comparative example, a differential impedance changes by approximately ±4%. In contrast to this, in a case where the electrodes 101, 404, and 405 each serving as a reference potential are present on the substrate 400 as in the present exemplary embodiment, a differential impedance changes by only ±1%. The absence of the electrode serving as a reference potential on the substrate 100 as in the comparative example leads to a change in a single-ended impedance by approximately ±5%. In contrast to this, with the presence of the electrodes 101, 404, and 405 serving as a reference potential on the substrate 400 as in the present exemplary embodiment, a single-ended impedance changes by only ±2%.

Thus, the analysis revealed that the use of the transmission apparatus 40 according to the present exemplary embodiment produces an advantageous effect of reducing the influence on the characteristic impedance due to a manufacturing error in the supporting members 121 and 122.

Such an advantageous effect of reducing the influence on the characteristic impedance resulting from a manufacturing error in the supporting members 121 and 122 is more significant in a case where the widths of the fourth and fifth electrodes 404 and 405 are greater than those of the supporting members 121 and 122. As for the substrate 400 according to the present exemplary embodiment, in a case where the widths of the supporting members 121 and 122 were set to 1 mm, and the widths of the fourth and fifth electrodes 404 and 405 each serving as a reference potential were changed, an analysis through a simulation was performed on the influence on the characteristic impedance with the occurrence of a manufacturing error.

In a case where the widths of the fourth and fifth electrodes 404 and 405 were set to 1 mm, and the widths of the supporting members 121 and 122 were set to 1 mm that is the same as the width of the corresponding electrode, the differential impedance was 97Ω, and the single-ended impedance was 52Ω. In contrast to this, in a case where the widths of the supporting members 121 and 122 became 1.5 mm, the differential impedance and the single-ended impedance respectively reduced to 92Ω and 49Ω.

Accordingly, the analysis confirmed that the arrangement of the fourth and fifth electrodes 404 and 405 with the widths wider than those of the supporting members 121 and 122 reduces fluctuations in characteristic impedance when there was a manufacturing error. Increase in the influence on the characteristic impedance with a manufacturing error in a case where widths of the fourth and fifth electrodes 404 and 405 are less than those of the supporting members 121 and 122 is caused by strong electromagnetic coupling that is brought by the supporting members 121 and 122 approaching the first and second electrodes 101 and 102 due to the manufacturing error.

The widths of the fourth and fifth electrodes 404 and 405 are made wider that those of the supporting members 121 and 122, so that electromagnetic coupling of the first and second electrodes 101 and 102 to the fourth and fifth electrodes 404 and 405 are kept strong. Thus, even in a case where the supporting members 121 and 122 become closer to the first and second electrodes 101 and 102, respectively, due to a manufacturing error, fluctuations in the characteristic impedance are reduced, which is desirable.

According to the present exemplary embodiment, a transmission apparatus that not only reduces the influence of a manufacturing error in the transmission apparatus, but also maintains communication quality and performs high-speed communication is realized.

Next, a transmission system according to a third exemplary embodiment is described.

A wireless communication system that is the transmission system of the present exemplary embodiment includes a signal transmitter that transmits a wireless signal and a signal receiver that receives the wireless signal transmitted from the signal transmitter.

### [First Example of Transmission System]

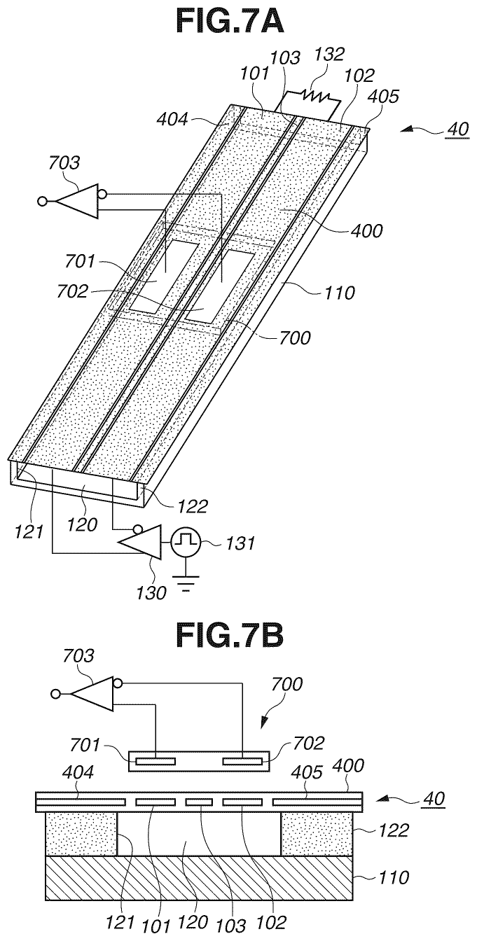

FIGS. 7A and 7B are schematic diagrams each illustrating a first example of a configuration of the transmission system according to the present exemplary embodiment. FIG. 7A is a perspective view of the transmission system, and FIG. 7B is a sectional view of a transmission line of the transmission system as seen from an extension direction.

In the first example of the wireless communication system, as illustrated FIG. 7A, the signal transmitter is a transmission apparatus including a transmission-side transmission line. Here, the signal transmitter is the above-described transmission apparatus 40 according to the second exemplary embodiment. The transmission apparatus 10 according to the first exemplary embodiment can be employed instead of the transmission apparatus 40.

The signal receiver serves as a reception-side transmission line 700. The transmission line 700 includes electrodes 701 and 702 and a reception circuit 703. The transmission line 700 is electromagnetically coupled to the transmission apparatus 40 in a non-contact state in which the transmission line 700 and the transmission apparatus 40 are kept spaced a certain distance apart, and performs wireless communication. The transmission line 700 includes the electrode 701 facing a first electrode 101 of the transmission apparatus 40, and the electrode 702 facing a second electrode 102 of the transmission apparatus 40. The transmission line 700 moves along an extension direction of a differential transmission line in the transmission apparatus 40, and receives a wireless signal from the transmission-side transmission line. The wireless signal received by the transmission line 700 is detected as a received signal by the reception circuit 703. As for an input impedance of a signal source 131 of the transmission apparatus 40, an impedance substantially equal to a differential impedance of the transmission line is used.

Here, consider a case in which a transmission apparatus having no electrode that serves as a reference potential on a substrate is used instead of the transmission apparatus 40 in the wireless communication system. In such a transmission apparatus having no electrode serving as a reference potential, a change in differential impedance due to a manufacturing error causes an impedance mismatch in a point at which the signal source 131 connects to the differential transmission line, so that a signal to be transmitted becomes smaller. Accordingly, a signal to be detected by the reception circuit 703 of the transmission line 700 becomes smaller, resulting in difficulty in performing high-speed communication. In contrast to this, in the present exemplary embodiment, the transmission apparatus 40 having an electrode serving as a reference potential on a substrate is used, so that a differential impedance hardly changes with a manufacturing error in the transmission apparatus 40. Hence, a high-speed communication can be readily performed, and a high communication quality can be maintained.

### [Second Example of Transmission System]

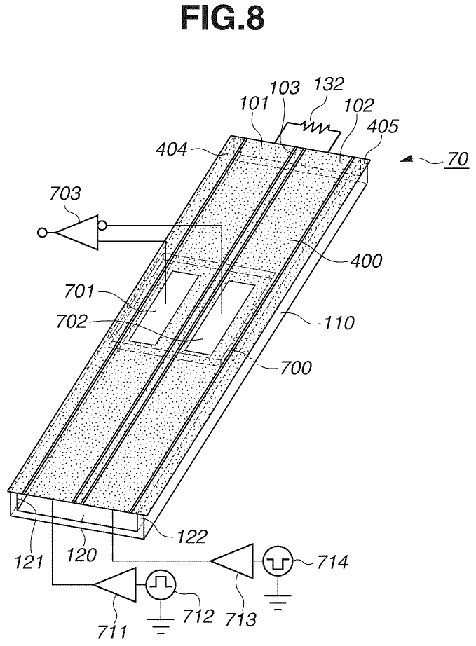

FIG. 8 is a perspective view illustrating a second example of a configuration of the transmission system according to the present exemplary embodiment.

In the wireless communication system of the second example, a transmission apparatus 70 that is a signal transmitter differs in a differential-signal input method from the transmission apparatus 40 of the first example. In the transmission apparatus 70, independent signal sources 711 and 712 and transmission buffers 713 and 714 are respectively connected to first and second electrodes 101 and 102, and single driving is performed. As for an input impedance of the signal sources 711 and 712, an impedance substantially equal to a single-end impedance of a differential transmission line is used.

Here, consider a case in which a transmission apparatus having no electrode serving as a reference potential on a substrate is used instead of the transmission apparatus 70 in the wireless communication system. In the transmission apparatus having no electrode as a reference potential, a change in differential impedance due to a manufacturing error causes an impedance mismatch in a point at which the signal source 131 connects to the differential transmission line, so that a signal to be transmitted becomes smaller. Consequently, a signal to be detected by a reception circuit 703 of a transmission line 700 becomes smaller, resulting in difficulty in performing high-speed communication. In the present exemplary embodiment, in contrast to this, the transmission apparatus 70 having an electrode serving as a reference potential on the substrate is used, so that a differential impedance hardly changes with a manufacturing error in the transmission apparatus 70. Thus, a high-speed communication can be readily performed, and a high communication quality can be maintained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-179582, filed Oct. 18, 2023, which is hereby incorporated by reference herein in its entirety.

What is claimed is:

1. A transmission apparatus that transmits a signal by electromagnetic coupling to another communication apparatus and extends in a predetermined direction, the transmission apparatus comprising:
a conductor; and
a substrate including a first electrode, a second electrode, and a third electrode,
wherein, on a plane perpendicular to the predetermined direction, the third electrode is positioned between the first electrode and the second electrode, and
wherein the conductor and the third electrode function as a reference potential of the first electrode and the second electrode.

2. The transmission apparatus according to claim 1, wherein a degree of coupling of the first electrode to the third electrode and a degree of coupling of the second electrode to the third electrode are respectively greater than a degree of coupling of the first electrode to the conductor and a degree of coupling of the second electrode to the conductor.

3. The transmission apparatus according to claim 1, wherein the first electrode, the second electrode, and the third electrode are positioned on a plane of the substrate.

4. The transmission apparatus according to claim 1, wherein a supporting member for supporting the substrate is disposed on the conductor.

5. The transmission apparatus according to claim 4, wherein a void is disposed between the conductor and the substrate with the supporting member.

6. The transmission apparatus according to claim 1, wherein the third electrode and the conductor are connected at an end in the predetermined direction and are at a same potential.

7. The transmission apparatus according to claim 1,
wherein the substrate further includes:
a fourth electrode adjacent to the first electrode; and
a fifth electrode adjacent to the second electrode, and
wherein the fourth electrode and the fifth electrode function as the reference potential of the first electrode and the second electrode.

8. The transmission apparatus according to claim 7, wherein the first electrode, the second electrode, the third electrode, the fourth electrode, and the fifth electrode are positioned on a plane of the substrate.

9. The transmission apparatus according to claim 7, wherein a supporting member for supporting the substrate is disposed on the conductor.

10. The transmission apparatus according to claim 9, wherein a void is disposed between the conductor and the substrate with the supporting member.

11. The transmission apparatus according to claim 9, wherein the supporting member includes a conductor.

12. The transmission apparatus according to claim 9, wherein, on a plane perpendicular to the predetermined direction, a center position of the fourth electrode and a center position of the fifth electrode each match a center position of the supporting member.

13. The transmission apparatus according to claim 9,
wherein, on a plane perpendicular to the predetermined direction, a width of the fourth electrode and a width of the fifth electrode are each greater than a width of the supporting member.

14. The transmission apparatus according to claim 8, wherein the third electrode, the fourth electrode, and the fifth electrode are connected to the conductor at an end in the predetermined direction and are at a same potential.

15. The transmission apparatus according to claim 1, wherein the substrate includes a flexible printed-circuit board.

16. A wireless transmission system comprising:
a signal transmitter including a transmission apparatus extending in a predetermined direction; and
a signal receiver electromagnetically coupled to the transmission apparatus,
wherein the transmission apparatus includes:
a conductor; and
a substrate including a first electrode, a second electrode, and a third electrode,
wherein, on a plane perpendicular to the predetermined direction, the third electrode is positioned between the first electrode and the second electrode, and
wherein the conductor and the third electrode function as a reference potential of the first electrode and the second electrode.
